(19) United States
(12) Patent Application Publication
(10) Pub. No.: US 2014/0229212 A1
(43) Pub. Date: Aug. 14, 2014

(54) METHOD AND SYSTEM FOR MANAGING CONSTRUCTION PROJECTS

(71) Applicants: Sandy MacElheron, Edmonton (CA); Gang Hong, Calgary (CA); Ben Swan, Yorkton (CA)

(72) Inventors: Sandy MacElheron, Edmonton (CA); Gang Hong, Calgary (CA); Ben Swan, Yorkton (CA)

(21) Appl. No.: 14/345,894

(22) PCT Filed: Sep. 19, 2012
(86) PCT No.: PCT/CA2012/000863

§ 371 Date: Mar. 19, 2014

Related U.S. Application Data
(60) Provisional application No. 61/536,446, filed on Sep. 19, 2011.

(51) Int. Cl. G06Q 10/06; G06Q 50/08

(52) U.S. Cl. CPC G06Q 10/063118; G06Q 10/063114; G06Q 50/08
USPC 705/7.15; 705/7.17

(57) ABSTRACT

Methods and systems for managing construction projects are provided. The methods and systems can be based on component-associated data where components can be assigned identifiers, drawings, cost codes, and man-hour values according to industry standards. Components can be grouped, sorted, searched and accessed through a database (a component library). Project schedules and work packages can be formed based on components and their associated data through a planning system. The schedule can be altered at the component level by adding or removing components, or stretching or shrinking the schedule. Constraints can be used to restrict a schedule or work package from being released until the constraints are satisfied. Once released, schedules can be updated to track construction progress of the project underway through a tracking system. Reports can be generated to reflect productivity of construction crews or individuals and track progress of the project.

### CROSS-REFERENCE TO RELATED PATENT APPLICATIONS

This patent application claims the benefit of U.S. Provisional Patent Application No. 61/536,446, filed on Sep. 19, 2011, the entire teachings and disclosure of which are incorporated herein by reference thereto.

### FIELD OF INVENTION

This invention generally relates to the field of construction management, in particular to the management of material, labour, scheduling and cost of a construction project. More specifically, the present disclosure provides systems and methods, as well as a component-centric modeling scheme, for predicting and tracking of progress and productivity on a construction project.

### BACKGROUND

In many large-scale construction projects, for example the major oil and gas construction projects budgeted over $800 M, productivity is typically quite low (about 35 to 40%), and it is not uncommon to experience cost overruns of up to 100% of the original cost estimates. The need for appropriate project planning and efficient progress tracking becomes even more important when cost is the major concern for these projects being successful from an operational standpoint.

Projects today are typically planned to result in Construction Work Packages (CWPs), and field supervision is responsible for converting a CWP into lists of assigned tasks for work crews and ensuring that all required resources and information are in place prior to work starting. However, most construction projects get lost facing the enormous amount of data and the different states of the data in project life cycle, and productivity is only measurable at a macro discipline level. Current methods to report on task or project status completion, such as paper-based tracking system, Key Performance Indicators (KPIs) tracking system and Earned Value management, can cause field manpower spikes and massive confusion when turning to project completion. In addition, current systems involve getting as much material as possible to site before work begins, this in turn results in significant costs in maintaining and storage where space is often a concern.

In addition to assigning dates to project activities, project scheduling is intended to match the resources of equipment, materials and labor with project work tasks over time. Some prior art methods include construction schedule creation, and allow the selection of visualised components to be effected by a schedule playback. However, there is no real tie to a project schedule, as many construction elements are only 3D modelled as groups of components or assemblies, and no onsite resource information is accompanied with these components. Due to the detailed nature of a construction project, any planning or tracking at higher than the component level is not sufficient.

A previously developed method intended to cover the whole construction process, from material take-off (MTO), creating work packages, to scheduling, time/cost estimate and turnover, has the intention to improve the efficiency of project management by mapping engineering data into constructible elements and organizing constructible elements by construction crafts, areas and systems. However, this method is still a system based on an activity-oriented, as opposed to a component-based strategy. The elements in this method are not components but work packages with some information of components being collected, which results in limited tools for project management when schedule granularity increases. For instance, estimation of time and cost cannot go to a detail level beyond a work package level, and as such, does not provide accurate measurements for project management to evaluate the crew performance. In addition, as not all the project information is associated with components, project management team might encounter problems with tracking schedule changes, handling extra work requests, manipulating the turnover, etc.

Component state models have been previously proposed to assess the constructability of projects. These models are used to determine when to release a task or activity. For example a 4D simulation scheme was proposed where a work breakdown structure can be used to link a schedule with a 3D model. These models, however, were only partially researched and the associated model and schedule were not complete. In addition, these methods only aim at determining the time to start an activity by considering the constraints related to components.

Hence, it would be desirable to provide systems and methods for managing construction projects that overcomes the shortcomings in the prior art.

### SUMMARY

Methods and systems for managing construction projects are provided. The methods and systems can be based on component-associated data where components can be assigned identifiers, drawings, cost codes, and man-hour values according to industry standards. Components can be grouped, sorted, searched and accessed through a database (a component library). Project schedules and work packages can be formed based on components and their associated data through a planning system. Project schedules and work packages can be discipline specific. The schedule can be altered, for example, stretched or shrunk at the component level by adding or removing components. Constraints can be used to restrict a schedule or work package from being released until the constraints are satisfied. Once released, schedules can be updated to track construction progress of the project underway through a tracking system. Reports can be generated to reflect productivity of contractors, construction crews or individuals, and track progress of the project by trade discipline, construction work package (CWP) and installation work package (IWP), as well as by system.

In some embodiments, a website (for example, a SharePoint™ website) can be deployed for document control, and portable computers (such as tablets) can be used to collect onsite project information. In some embodiments, different stages can be followed to manage a construction project from deconstructing engineering information, rebuilding constructible component libraries, reallocating components to schedule activities and work packages, to tracking the construction progress at component level, and generating various reports. The methods and systems within the present construction management system can be based on a component-centric modeling scheme, where components can be associated with various types of project information, and can be grouped, sorted, searched and accessed through a database.

In an aspect, some embodiments can provide a construction management system, that can comprise a database containing component library, a SharePoint™ website designed for document control, a planning system to create Installation Work Packages (IWPs) associated with level 4/5 schedules and relevant resources for construction (such as material, equipment, tools, crews, etc.), a tracking system to manage construction progress/reports, and computers (such as tablets, although laptops, smartphones, or handheld devices would do) adapted to collect construction data from the field.

Implementation of the system can include one or more the following. Components can be grouped, sorted, searched and accessed through a database. Work packages can be formed based on components and their associated data. Project schedules can be altered at the component level by adding or removing components to stretch or shrink the schedule. Constraints used to restrict a schedule or work package from being released can be created based on the information of the components tied to the schedule or work package. Once the constraints are satisfied, the schedule or work package is released and updated to track construction progress of the project underway. Reports can be generated to reflect productivity of construction crews or individuals and track progress of the project.

The methods and systems of the present disclosure can be developed based on a component-oriented philosophy that the activities in a given project can be organized around components. The methods and systems can present various tools for project management at the granularity of a component level. The methods and systems can comprise schedule visualization, material management, visualization work packaging, change management clarity, and crew performance tracking. The methods and systems can be comprehensive, multidisciplinary and powerful applications that help users to simulate construction projects in advance to better design, plan, and implement large-scale construction projects.

In an aspect, some embodiments can establish a component-centric modeling scheme that the construction management system is based on. With this scheme, construction information is organized around components. The methods and systems of the present disclosure can focus on the components of the engineering drawings within a given project, not limiting itself to those components that have been visualized in the 3D model. Furthermore, components can be integrated with project information from additional sources, other than solely with engineering model files, to construct component libraries. By incorporating components of a construction project, scheduled activities, which make up CWPs and IWPs, can be associated directly to the components of one or multiple engineering drawings. This association can allow for all facets of the construction project, including the 3D model, schedule, progress and productivity tracking, to be linked by the individual components comprising the project.

The methods and systems can provide various tools for project management to manage/schedule/analyse/review/alter the project at the granularity of component level. Construction management process, including work packaging, activities scheduling, productivity measurement, crew performance tracking, and reports generation, can be conducted around component categories. The methods and systems can comprise schedule visualization, material management, visualization of work packaging, change management clarity and crew performance tracking. The methods and systems can be comprehensive, multidisciplinary and powerful applications that can help users to simulate construction projects in advance to better design, plan, and implement large-scale construction projects.

The methods and systems can comprise the incorporation of the components of a construction project into an IWP, building work schedules from the component data, as opposed to hard keyed inputs or a system/assembly of components, constructing budgets from unit rates assigned to each component, as opposed to key performance indicators, tracking productivity down to the component level, a full integration of a 3D model, schedule and budget, the integration of multiple construction disciplines, an increased accuracy and efficiency in preparing budget and man-hour baselines, and increased productivity and progress tracking.

In some embodiments, project management team can know the status of activities/tasks and can further progress of work packages by tracking the states of components. By recording the rules of credit of components, project executives can measure crew performance and further the productivity of a project team. By changing the cost codes which group relevant components, project executives can adjust the budgets down to the component level to match environmental, or other, changes.

Broadly speaking, a method for managing a construction project based on component data is provided, the method comprising: associating component data with project information such as construction activities, resources, man hours, and budgets; grouping component data into a database; sorting component data into categories depending on data use; creating work packages based on built-in tradesmen's expertise with constraints needing to be satisfied prior to the work package being released, the constraints comprising resources, budgets, safety and quality information that relate to the components in the work package; and building a schedule by arranging activities according to a release date of work packages, the release date determined by the satisfaction of the constraints; wherein the component data and schedule are used to manage the construction project.

In some embodiments, the method for managing a construction project can further comprise updating the schedule by tracking a state of a components, generating reports on a performance evaluation of the construction project, retrieving the component data by loading the component data into a tablet or hand-held device, for example wherein the component data are loaded into the tablet or hand-held device from the database via a portable computer; retrieving a plurality of components from the database; presenting the plurality of components to a user; receiving a selection of one of the components that has been performed on the project identified by a selected identifier from the user; comprising a value identifying the selected component; and associating a number of hours worked with the selected identifier; providing a means to develop cost codes to group components into categories, the means comprising an algorithm to adjust proportions of cost codes according to change of project budget; providing a means to estimate a project cost at a level of granularity where the level is selected from a group consisting of component, IWP, CWP, discipline, and project, the means comprising an algorithm to collect man hours from engineering drawings by industry standard rates; and/or providing a means to evaluate a work crew's performance down to a component level, the means comprising an algorithm to calculate productivity and generate reports.

In some embodiments, a computer-readable storage medium is provided having code embodied therein for causing a computer to perform any of the present methods.

Broadly speaking, a system for managing construction projects is provided, the system comprising: a database; memory; a processor for executing code stored in the memory; a component interface operative to receive component identifiers identifying components of a construction project; a database interface operative to store the component identifiers in the database and further operative to update a construction status of the component identified by the component identifiers; and a component query interface operative to receive component queries comprising the component identifiers; wherein the database interface is operative to search the database and to provide indicators associated with the received component identifiers and their construction status.

In some embodiments, the system according can further comprise a viewer, the viewer comprising: an application program interface operative to provide the component queries to the component query interface, and to receive the indicators from the database; and a display operative to display graphical representations of the components based on the received indicators; a remote data entry device, the remote data entry device comprising: a user input device operative to receive time values from a user;

and an application program interface operative to provide the time values and associated component identifiers to a time interface; and/or a simulation interface operative to provide a 4D simulation with autonomous agents making decisions on resource allocation, collaborative working among disciplines, evaluation on risks of changes, and predictions of a 16-weeks look ahead, the simulation interface comprising: a method to detect conflicts; a protocol for agents to do negotiation on limited resources; an algorithm to evaluate risks of changes, where the algorithm comprises means to handle the propagation of a change along the work flow.

Broadly speaking, a software program for managing a construction project based on component data, embodied on a computer readable medium is provided, the software program comprising: current state information for at least one component and its design; decision and accountability information tracking each component and its design up through its current state; a subsystem further comprising: a component database; a search and cross reference engine, operating in coordination with the component database; wherein for each distinct project initiated by a human user the database, engine, and subsystem exchange data with the human user and amongst each other, and in accordance with the decisions and constraints entered by the human user and contained within the software program, produce as an output at least one report of at least one schedule and supporting documentation associated with the schedule.

In some embodiments, the software program can further comprise wherein the database is a relational database which can track and make use of the relationships between and amongst the attributes of its data; wherein the database tracks for each distinct project a design state, supporting materials state, current interaction, human user, and progress on any associated report, validation, verification, and documentation requirement, from inception through completion of that distinct project; wherein the search and cross-reference engine further comprises: means using a constraint-based approach for rapid classification and identification of identical, similar and like components; means for reporting for display to a human user both: (a) all components matching the constraints provided to the search and cross-reference engine; and, (b) for each such component, the particulars contained in the databases of such component; and, means for using a comparative description for each attribute and constraint rather than a component's description in a manufacturing perspective, to provide a unified standard of comparison across different manufacturers; wherein the subsystem further comprises: mean for collecting, collating, and managing the details for each and every component comprising a part of each project; means for providing the current representation of the project to the human user in accordance with the human user's expressed desire, further comprising: means for providing a graphical representation; means for providing a textual representation; means for providing a list representation; means for providing a dependency-tree representation; and, means for providing any combination of the above, depending on the human user's desire for more or less detail concerning the current state of the project involving that component; wherein the subsystem further comprises: for each project: means for managing the documentation; means for tracking, for accountability purposes, the human sources for changes as they are made; and, means for transferring a component and its associated documentation from one group to another group; means for identifying uncompleted components or schedules; and means for alerting a human user to such; means for managing design generation information; and, means for managing support for user generation, dissemination, emendation, tracking, and comparison of documents relevant to the user's engineering, document control, manufacturing, purchasing, procurement, inventory, and other management concerns; means for connecting to an Internet/Intranet; means for searching across the Internet/Intranet for all potential replacements for any component contained in any of the software program's databases; and, means for reporting the possibility of such replacement to the human user; an extension to the search and cross-reference engine that enables any search to use multiple attributes simultaneously; and/or a database structure for storing information comprising full facets of component data in a project as well as relation information that track the components in different disciplines.

Broadly speaking, a computerized method for using a commerce application of managing a construction project based on component data is provided, comprising: in a first computer process executed by a computer processor, associating component data with project information such as construction activities, resources, man hours, and budgets; in a second computer process executed by a computer processor, grouping component data into a database; in a third computer process executed by a computer processor, sorting component data into categories depending on data use providing a base to manage the project; in a fourth computer process executed by a computer processor, creating work packages based on built-in tradesmen's expertise with constraints needing to be satisfied prior to the work package being released, the constraints comprising resources, budgets, and safety and quality information that relate to the components in the work package; in a fifth computer process executed by a computer processor, building a schedule by arranging activities according to a release date of work packages, the release date determined by the satisfaction of the constraints; in a sixth computer process executed by a computer processor, updating the schedule by tracking a state of a components; and in a seventh computer process executed by a computer processor, generating reports on a performance evaluation, and in an eighth computer process executed by a computer processor, displaying the information further comprises selectively displaying information selected from a group consisting of a two-dimensional graphical model, a three-dimensional graphical model, text, a bill of materials, and any combination thereof.

In some embodiments, the methods can further comprise providing the user with the ability to edit the information.

In some embodiments, a computer-based system for managing construction projects is provided, comprising: a database containing component libraries storing full facets of component information in a given project as well as the relation information that help track the components in different disciplines; a SharePoint™ website for document control; a planning system for creating work packages with resource loaded level 4/5 schedule line items; a tracking system for managing construction progress; tablet computers adapted to collect construction site information.

In some embodiments, a component-centric modeling scheme to organize project information around components is provided, said model comprising: associating component data with project information comprising construction activities, resources, man hours, budgets, etc.; grouping component data into categories depending on data use which provides an efficient base to manage the mega project with large size and complexity of data modeling; creating work packages based on the built-in tradesmen's expertise with a list of constraints needed to be satisfied prior to the work being released, said constraints comprising resources, budgets, safety and quality that related to the components in the work package; building a schedule by arranging the activities according to the release date of work packages, said release date decided based on the satisfaction of components' constraints; updating the schedule by tracking the states of the components; and generating reports on performance evaluation even down to the worker level.

In some embodiments, methods are provided, the methods developed based a component-centric modeling scheme comprising: a method to develop cost codes to group components into categories, said method comprising an algorithm to adjust the proportions of cost codes according to the change of project budget; a method to estimate the cost as to different granularity (i.e., component, IWP, CWP, discipline and project), said method comprising an algorithm to collect man hours from engineering drawings by industry standard installation rates; and a method to evaluate crew's performance that can be down to component level, said method comprising an algorithm to calculate the productivity and generate reports.

### BRIEF DESCRIPTION OF THE DRAWINGS

Some embodiments of the present methods and systems will be described in detail based on the following figures, wherein:

FIG. 1 is a block diagram depicting a structure of an embodiment of a method and system for managing a construction projects.

FIG. 2 is a block diagram depicting stages of managing construction projects using an embodiment of the method and system.

FIG. 3 is a block diagram depicting an embodiment of building a component library by deconstructing project information.

FIG. 4 is a block diagram depicting an embodiment of reallocating components to schedule line items.

FIG. 5 is a block diagram depicting an embodiment of updating schedule line items by tracking onsite component status.

FIG. 6 is a block diagram depicting an example of reallocating components to schedule line items.

FIG. 7 is a block diagram depicting an example of creating an Installation Work Package (IWP).

FIG. 8 is a sample table depicting an example of a data loader for cables produced from one embodiment of the method and system.

FIG. 9 is a sample table depicting an example of estimated unit rates for a piping system produced from one embodiment of the method and system.

### DETAILED DESCRIPTION OF EMBODIMENTS

Methods and systems are provided for managing construction projects at a component level that can define project scope and work break down structure, can allow component allocation to a project schedule, and can provide crew performance reviews.

In some embodiments, the methods and systems can comprise a component-based construction management system which can organize project information around component categories. In some embodiments, the methods and systems can be based on the concept that activities throughout a construction process can be carried out around components. In some embodiments, project information can be associated with components, which can provide a spectrum of tools to manage projects. Components managed within the method and system can be packaged into bid packages, work packages, turnover packages while maintaining their project hierarchy, related system, scheduled install etc. In some embodiments, these trade discipline packages can then be progressed through rules of credit for each component or task, automatically assigning crew actual hours to correct cost codes while simultaneously updating schedule progress back to the project schedule and updating real time dashboards, reporting progress, performance and system progress.

This disclosure provides systems and methods that can equip a project executive team with the necessary tools to plan and track a construction project through gathering, managing and disseminating a very large amount of information accompanying the construction project, including but not limited to model files, materials, labors, scheduling and cost.

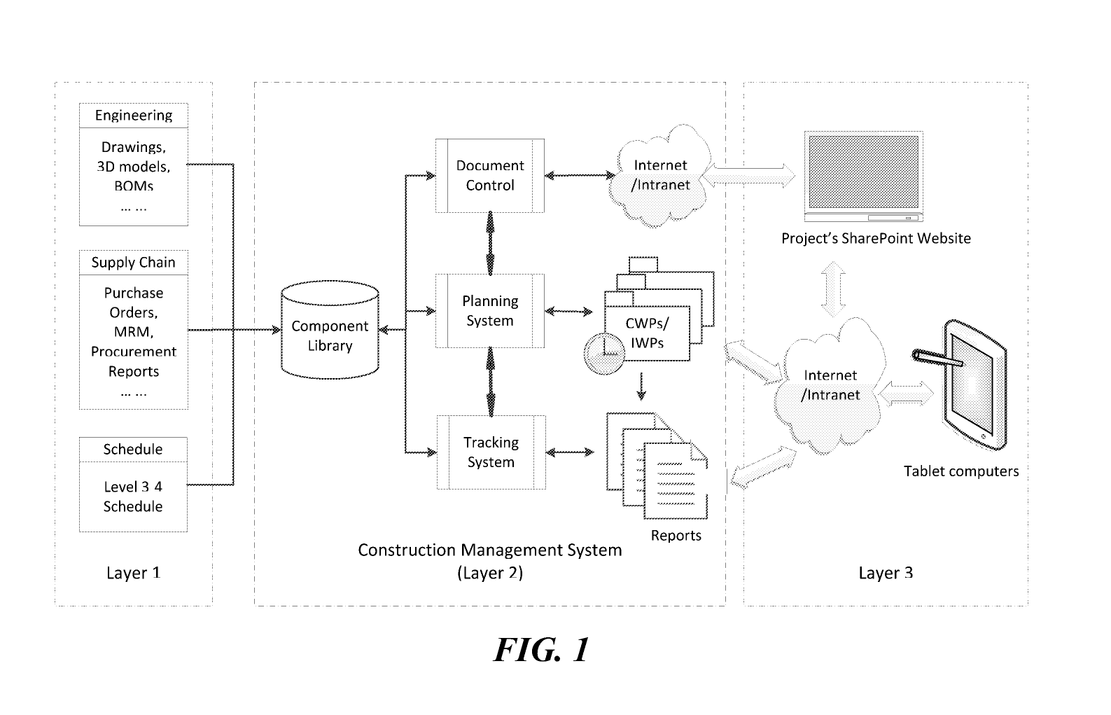

Referring now to FIG. 1, an example structure of embodiments of the present systems and methods is illustrated. Generally, three layers can be classified in a typical construction project management process. The first layer represents the input, including engineering information, supply chain information, schedule information, etc. The second layer can be the present construction management system which can implement document control, project planning and project tracking. The major output of the present construction management system can comprise various work packages (CWPs/IWPs) with resource loaded level 4/5 schedule that guide onsite construction in layer three. The field feedback collected by tablet computers, such as the timesheets, RFI (Request for Information), EWR (Extra Work Request), etc., can be sent back to the present construction management system via internet/intranet to generate various reports and productivity reviews.

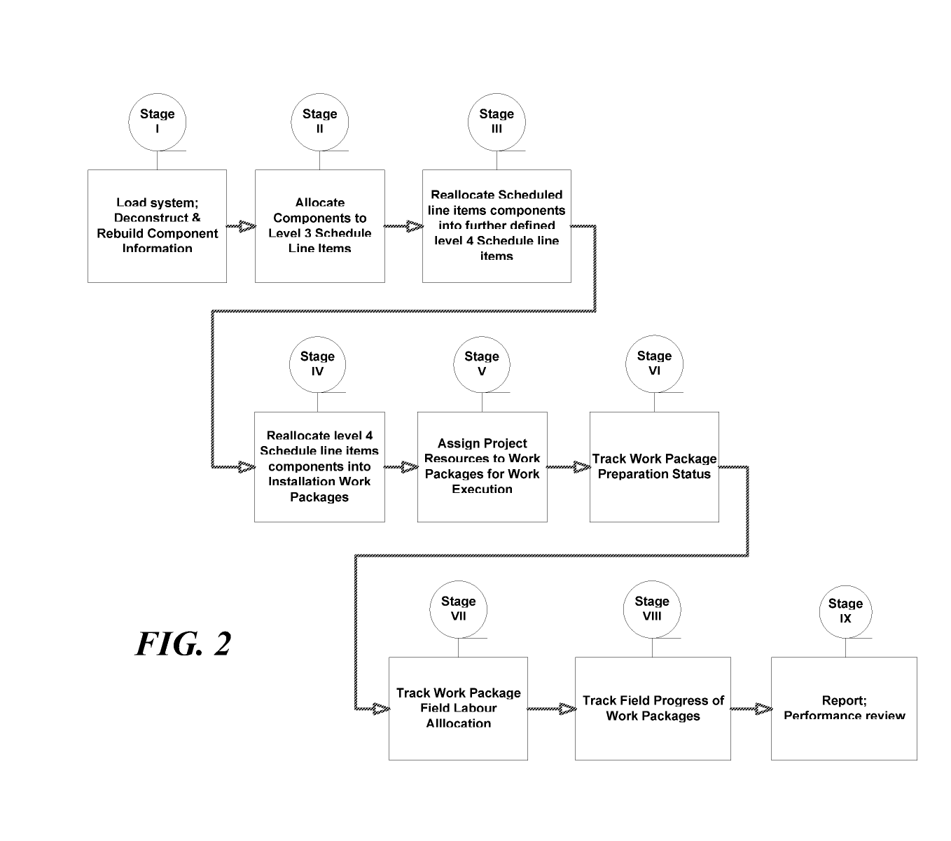

FIG. 2 depicts an example of stages which can be used to manage a construction project using the present methods and systems. In this example, nine stages are shown, however, as any number of appropriate stages could be used.

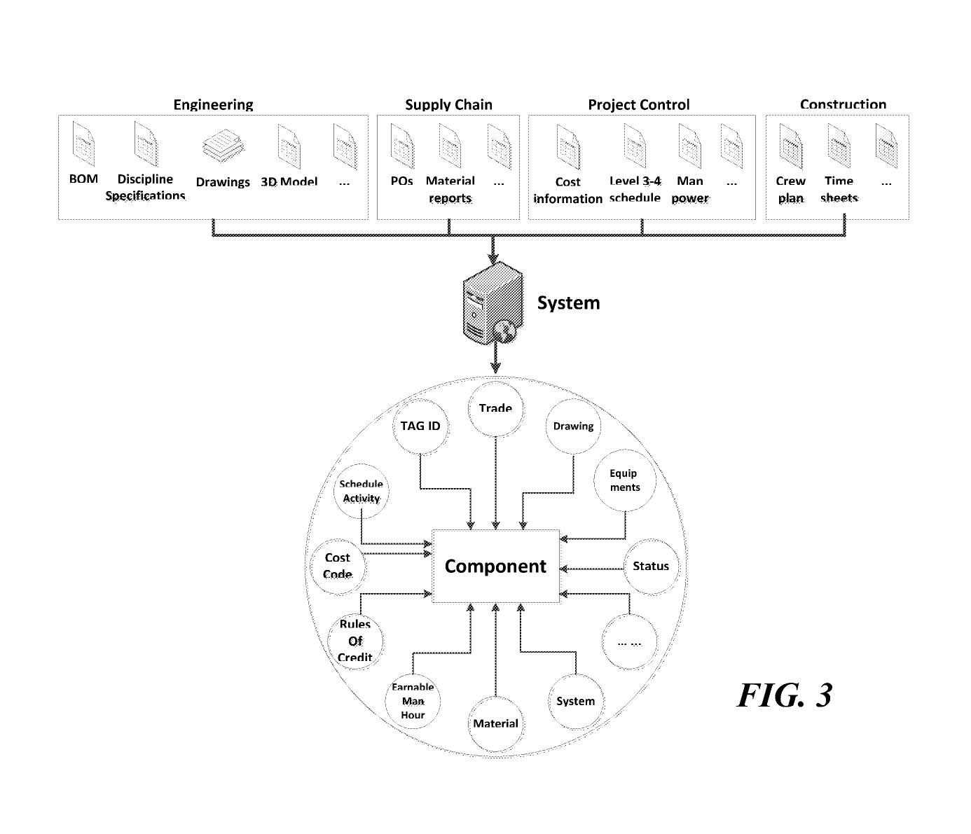

In some embodiments, stage I can comprise loading the system as well as deconstructing and rebuilding component information; stage II can comprise allocating components to level 3 schedule line items; stage III can comprise reallocating scheduled line item components into further defined level 4 schedule line items; stage IV can comprise reallocating level 4 schedule line item components into Installation Work Packages; stage V can comprise assigning project resources to work packages for work execution; stage VI can comprise tracking work package preparation status; stage VII can comprise tracking work package field labour allocation; stage VIII can comprise tracking field progress of work packages; and stage IX can comprise providing reports and performance reviews. At stage I, relevant project information, including but not limited to engineering information (such as drawings, 3D models, BOMs (Bill of Materials), specifications, etc.), supply chain information (such as POs (Purchase Orders), material procurement reports, etc.), project control information (such as cost information, level 2-4 schedule, man power, etc.), and construction site information (such as crew plan, timesheets, RFI, EWR, etc.), can be dumped into the present construction management system, and then be further ground to achieve higher granularity by deconstructing and rebuilding the constructible elements as shown in FIG. 3. Project information can be classified into categories, such as skid lists, cost information, equipment lists, discipline specific lists, PDF drawings, 3D model files, PCF/IDF/CIS2 txt files, system lists, and line designation tables. These categories can be defined in a general perspective. In some embodiments, project information can be broken down to a component level and further analyzed to be associated with components. In other words, the component data can be grouped into categories depending on data use, and each component can be defined as an information library, or metadata, which can contain individual information of a component, such as trade, area, system, line, TAG ID, drawing, model image, cost code, rule of credit, estimated man hour, schedule activity, status, etc.

In some embodiments, component libraries can be built that contain all components that make up a drawing, isometric, or different type of engineering data. Every component can be engineered, manufactured, delivered, installed and commissioned in order to start a project. Managing groupings or assemblies fails to ensure all components necessary have been accounted for and are ready for operation. In some embodiments, libraries can be created primarily from detailed engineering procurement text data that is imported with; manufacture number, related line/system. Within the method or system, man-hours, system relation, cost codes, 3D visual model image and other relevant information required for management can be attached to individual components. The method or system can maintain these records for multiple projects entered into the database as a library and can run future material lists through this library to have automated project component data with improved accuracy and speed. In some embodiments, the components, not limiting to 3D objects, can be modeled in the system. All the components can be associated with project information, such as resources, man hours, etc. This association can facilitate a 4D simulation or to re-arrange a schedule. A construction process for each component in the system can be modeled by its rules of credit, which can facilitate 4D simulation to display the construction process in details. In addition, minor adjustments to a schedule according to the environmental changes can be achieved by modifying the proportions of the rules of credit. In some embodiments, the method or system can employ a multi-agent mechanism to balance a construction process with regard to different disciplines involved.

In some embodiments, a project management team can develop a project schedule using a type of project management software, such as Oracle™ Primavera™ P6, although any suitable equivalent would do. In the present methods and systems, a project schedule can be re-generated by allocating components to activities. This re-allocation process can associate components with project schedule information, and can be carried out by a system operator to hierarchically assign components to schedules that would be known to one skilled in the art, for example: level 3 schedule line items (at stage II), level 4 schedule line items (at stage III), and IWPs (at stage IV).

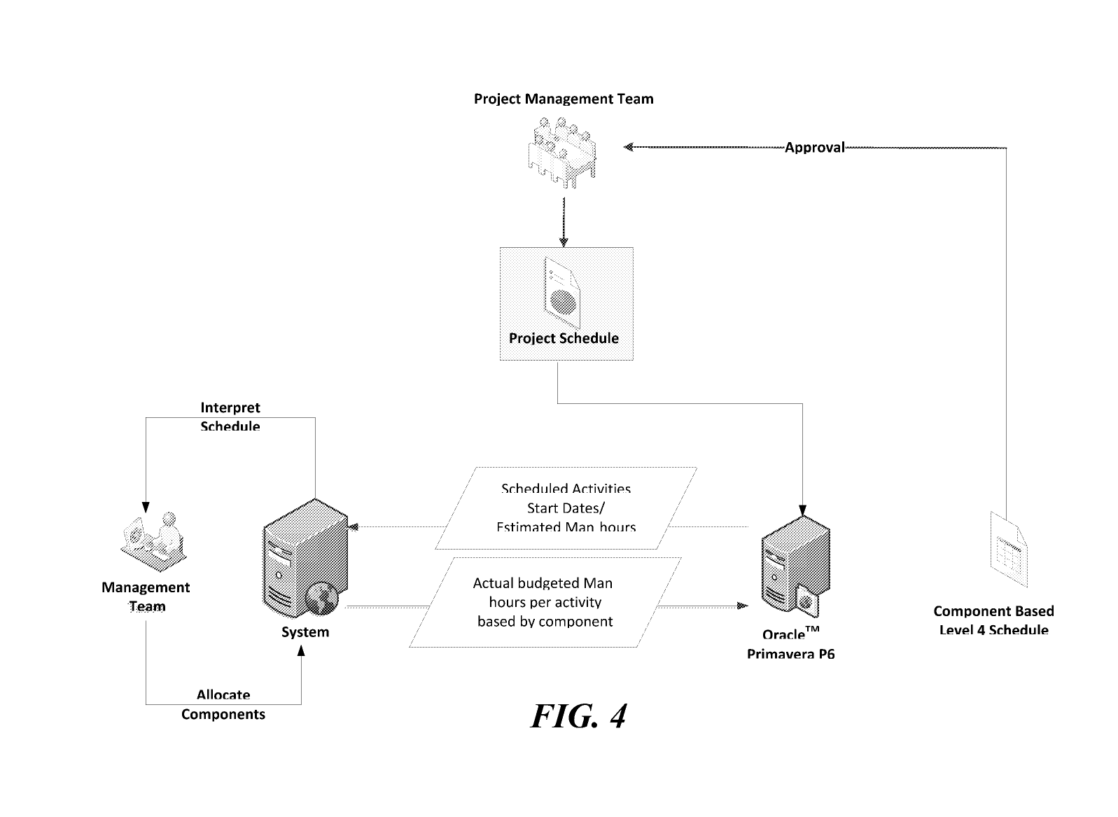

Regarding level 3 schedule which defines the overall critical path of planning, components can be allocated to line items of level 3 schedule based on major milestones. Referring now to FIG. 4, a typical process of allocating components to level 4 schedule line items is illustrated. A level 4 schedule is the detailed working level schedule developed by trade contractors. After being approved and integrated to project schedule, it can be transferred from the original database, e.g. Oracle™ Primavera™ P6, to the present construction management system. By allocating relevant components to each schedule line item and interpreting the schedule through the component centric modeling logic embedded in the present construction management system, the actual budgeted man hour for each activity in the given level 4 schedule can be achieved and updated to Oracle™ Primavera™ P6 database.

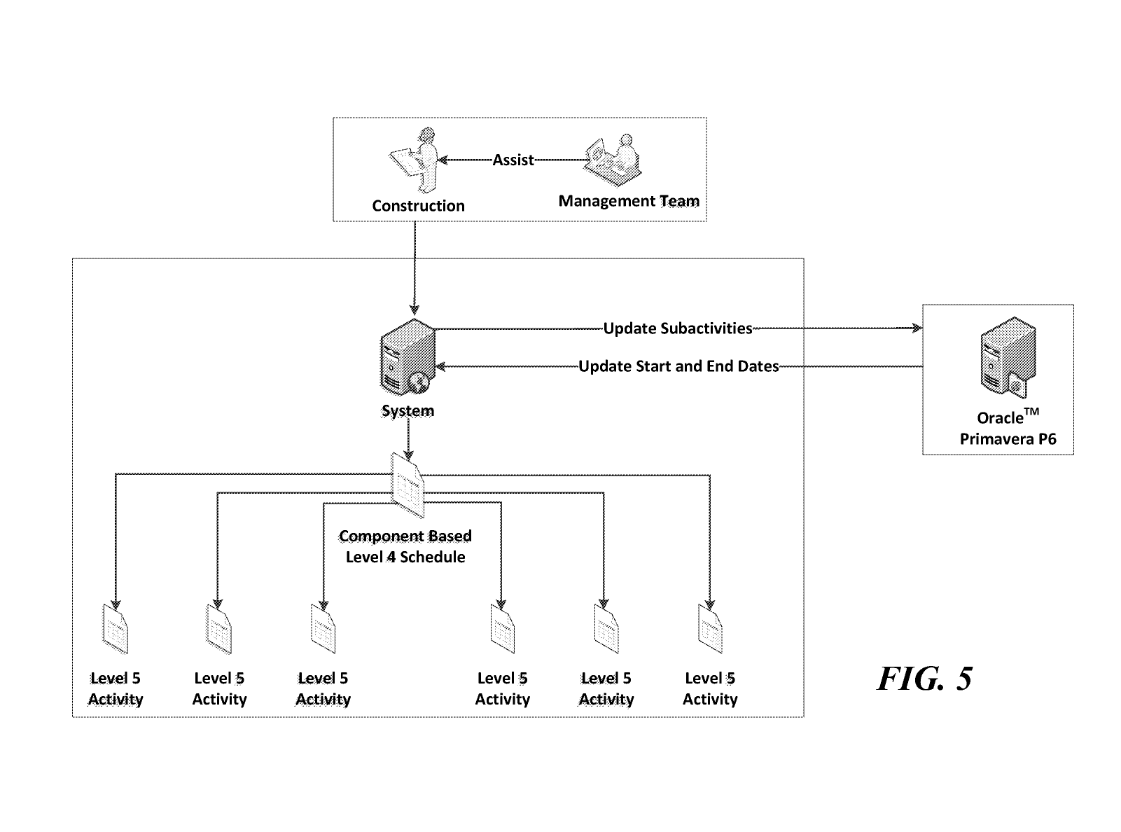

Referring now to FIG. 5, the level 4 schedule can be further broke down to level 5 schedule by the workforce supervisors with the assistance of the present construction management system. Usually, the level 5 schedule can be in the form of IWPs. The status of IWPs can be updated to activities stored in Oracle™ Primavera™ P6 database.

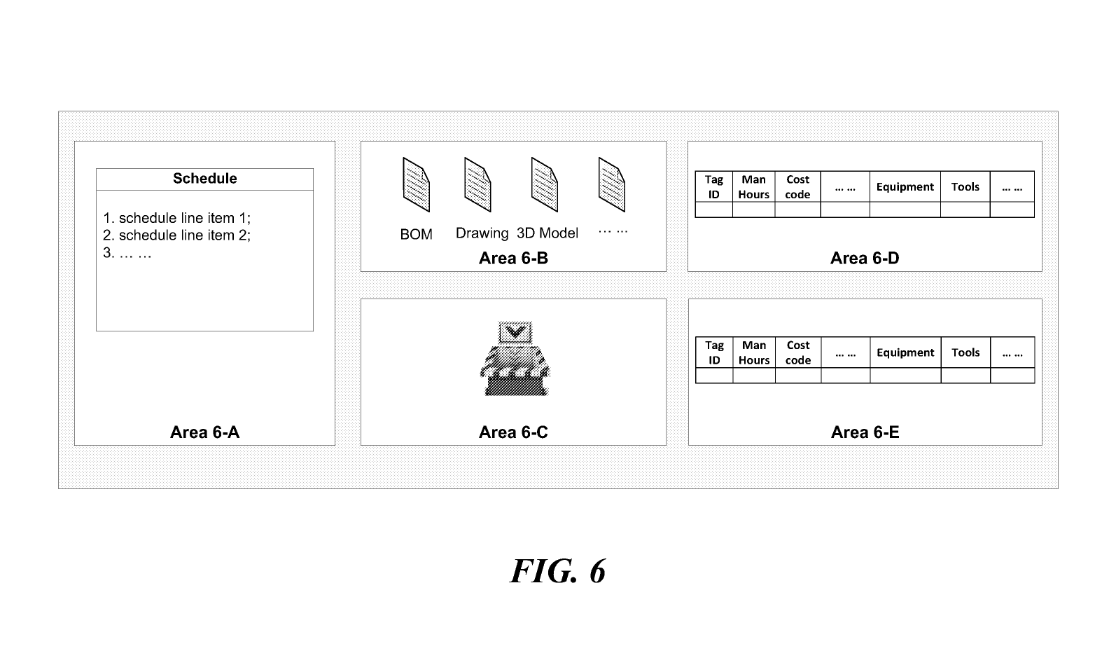

Referring now to FIG. 6, an example of allocating components to level 3/4 schedule line items is given. In this interface, schedule line items retrieved from Primavera™ P6 can be listed in area 6-A, and the relevant engineering files (e.g. drawings, bills of material (BOMs), etc.) can be presented in area 6-B. Each time when a system operator selects an engineering file, e.g. a drawing, the components depicted in the file can be tabulated in area 6-D with the associated project information, such as tag ID, earnable man hour, rules of credit, etc. Regarding each schedule line item, the system operator can drag and drop the selected engineering files to the “sandbox” 6-C; then the corresponding components, as well as the associated project information, can be assigned to the selected schedule line item, and listed in area 6-E.

The information-rich components managed within the present methods and systems can be packaged into bid packages, work packages, turnover packages while maintaining the project hierarchy, related system, scheduled activities, etc.

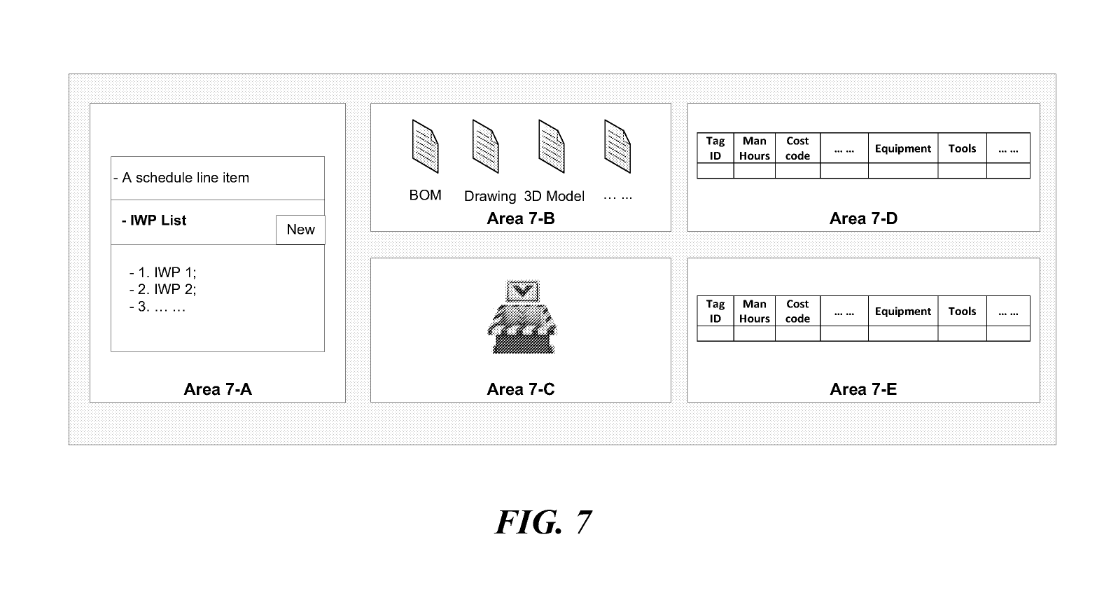

Referring now to FIG. 7, an example of building an IWP is illustrated. The operator can create a blank IWP under a selected schedule line item in area 7-A. The relevant engineering files (e.g. drawings, BOMs, etc.) to the selected schedule line item can be presented in area 7-B. At current stage, components within the engineering files are objects associated with relevant project information. Each time when a system operator selects an engineering file, e.g. a drawing, the components depicted in the file can be tabulated in area 7-D with the associated project information, such as tag ID, earnable man hour, rules of credit, etc. Regarding each IWP, the system operator can drag and drop the selected engineering files to the “sandbox” 7-C; then the corresponding components, as well as the associated project information, can be assigned to the selected IWP, and listed in area 7-E.

Since components are allocated to IWPs, resources related to the components can be assigned to the IWPs at stage V. Furthermore, the preparation status and field labor allocation can be monitored for IWPs at stage VI and stage VII. These operations formulate prerequisites for releasing IWPs for construction. As such, in some embodiments, a list of constraints including labour, materials, equipment, tools, safety issues, etc. related to the components can be required to be satisfied, before implementing the schedule activities or releasing the IWPs.

These trade discipline packages can then be progressed through rules of credit of each component at stage VIII. By automatically assigning actual crew hours to correct cost codes, the schedule progress is updated back to the project schedule, which in turn triggers the update of real time progress dashboards and performance reviews. In addition, minor adjustments to a schedule according to the environmental changes can be achieved by modifying the proportions of the rules of credit.

In some embodiments, project reports can be generated at stage IX. Due to the system's daily collection of field data, these reports can provide early insight to progress and productivity as work is being done which can highlight issues and concerns that can be quickly mitigated and resolved. The reports can also provide clarity into system progress allowing for more effective management of crew delegation for a more efficient completion of a project.

In the present methods and systems, each constructible element, or metadata, can be associated with all the necessary information for construction, such as tag ID, schedule activities, cost code, rules of credit, earnable man hour, material, equipment, tools, trades, etc. These constructible elements can constitute a component library that can have the capability to cover all the information accompanying a construction project. Originally, the component library can be developed based on disciplinary commodity libraries which can vary in some items from company to company.

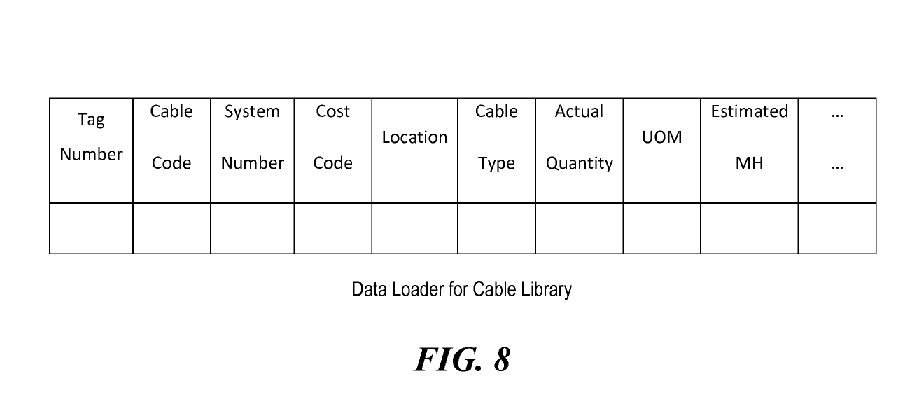

With the project being set up and initiated, the relevant project information, such as system types, project cost codes, rules of credit, earnable man hours, etc., is imported as material take-offs (MTOs). Accordingly, a data structure for each type of components is created to record all the related project information. In some embodiments, different types of data loaders can be developed to create relations between components and project information. Referring now to FIG. 8, an example of a data loader format for cables in an electrical module is shown. The data loaders for other construction modules, such as piping, scaffold, steel, mechanical, etc. can be developed in the similar way.

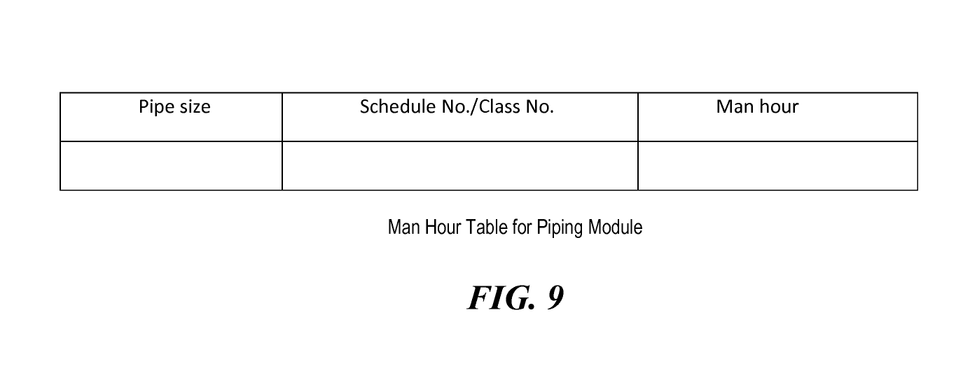

Algorithms can be developed to estimate man hours for components by reading a corresponding engineering drawing. In some embodiments, tables for man hours of standard components can be created. Referring now to FIG. 9 an example of a man hour table for a piping module is shown. In this table, the man hour for a linear foot pipe (or a fitting) with a specific diameter and a specific type can be collected based on industry standard installation rates. The estimated man hour for a piece of pipe in a piping module can be calculated by multiplying the corresponding man hour in a table by the length of the pipe (if the component is a fitting for example, then the estimated man hour of the fitting is equal to the man hour in a corresponding table).

As part of the man-hour estimation function, utilities can be used to recognize different types of components from the engineering drawings (such as DWG, PCF, etc.), as well as the parameters of these components. Since components can be allocated to level 3 schedule line items, level 4 schedule line items, and installation work packages (IWPs), the costs as to different granularity can be estimated.

In some embodiments, cost codes can be used to group relevant components into categories. A list of cost codes can be created when setting up a project. Then, components can be associated with individual cost codes when they are loaded into a project. Therefore, each cost code can represent a total man-hour amount regarding all the components it contains. In addition, the proportionate relations between components and a cost code can be recorded in the system database. A user can adjust the total man hour that a cost code represents, which can accordingly make changes on the individual man hours of the components using the recorded proportionate relations.

In some embodiments, the method or system can maintain the cost codes for both a project owner and a project contractor or either separately. In an embodiment, the components data can be separated into numerous groups and can maintain its budgeted install costs and cost category for accounting systems. The method or system can also include a means or a mechanism to manipulate the cost codes that can allow total man-hour baselines for each cost code control point to be brought up or down to match an original bid or to proportionally adjust the individual cost tracking codes of components in relation to each other regarding present project budgets. For example, component libraries can have “standard industry installation rates” and if a specific project has a discipline task that are all at grade level the standard industry rates may be suffice. However, if a contractor approached this project with a rate in their bid below the industry standard, then the system and methods can have the functionality to adjust all of the components within a given cost code to match the original bid. The method or system can also capture actual manpower hours expended to install each component and who installed the component. This can provide a productivity rate for each employee for each day.

In some embodiments, the methods and systems can allow grouping of components with their respective budgeted man hours to be associated with a project scheduled activity. Once components are attributed to a particular schedule line item they can effectively lengthen the duration of the line activity. This can benefit material sequencing for a project's material management group in understanding what is required for a scheduled time period.

In some embodiments, components can be packaged into a scheduled task. The methods and systems can allow project components to be grouped regardless of which drawing or even what CWP they are from. In some cases, there can be a need to do one task on a drawing but then need to return back to complete another part of the drawing. For example, one crew may install some junction boxes shown on a drawing, then later on another crew may use the same drawing to install the cable tray shown on that drawing, and yet another crew may use that same drawing and complete the grounding of the cable tray and junction boxes. Many projects can begin with bulk or area building, however in later stages of a project the construction workers will switch to “systems” building. This can allow workers to focus on completing systems (for example, such as UW (Utility Water) or a 600V system for energizing a MCC (Motor Control Center—a source of power/energy for equipment on commercial and industrial sites) to bump and run motors) that can be handed over to operations.

The methods and systems can consider the need to be able to report on system status completion as well as bulk status completion in all stages of project. The methods and systems can allow a sequential method of focusing on system completion earlier by providing the user with ongoing real time reports, when ongoing bulk construction is still underway.

The methods and systems can manage progress by allowing a user to progress the status on a component or rule of credit basis. In some embodiments, a field crew member's actual time to install a component can be tied to the system and can derive a productivity report for any given crew member. The methods and systems can provide productivity reports for individuals, crews, general foreman and entire disciplines.

In an example, an underflow pump installation can consist of many tasks to be completed which can range from initial delivery, placing, rough aligning, piping hook-ups, electrical terminations, fine alignment, grouting, etc. These tasks are not generally completed by one work crew but many different crews and most likely some from different contractors at different times. All the data to manage this task does exist but it generally is spread across different trade disciplines' drawings, isometrics and standard detail drawings. The methods and systems can allow for the planning, scheduling, progressing, turnover and actual performance of all those who were involved in the pump's installation.

Embodiments disclosed herein can be implemented as one or more computer program products, i.e., one or more modules of computer program instructions encoded on a computer-readable medium for execution by, or to control the operation of, data processing apparatus. For example, logic or software operable to carry out the methods disclosed herein may be provided in such computer-readable medium of a computer and executed by a corresponding processor or processing engine (not shown). The computer-readable medium can be a machine-readable storage device, a machine-readable storage substrate, a non-volatile memory device, a composition of matter affecting a machine-readable propagated signal, or a combination of one or more of them. In this regard, the computer may encompass one or more apparatuses, devices, and machines for processing data, including by way of example a programmable processor, a computer, or multiple processors or computers. In addition to hardware, the computer may include code that creates an execution environment for the computer program in question, e.g., code that constitutes processor firmware, a protocol stack, a database management system, an operating system, or a combination of one or more of them.

A computer program (also known as a program, software, software application, script, or code) used to provide any of the functionalities described herein can be written in any appropriate form of programming language including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program may include, by way of example, both general and special purpose microprocessors, and any one or more processors of any kind of digital computer. Generally, a processor will receive instructions and data from a read-only memory or a random access memory or both. Generally, the elements of a computer are one or more processors for performing instructions and one or more memory devices for storing instructions and data. The techniques described herein may be implemented by a computer system configured to provide the functionality described.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

### REFERENCES

The following documents are incorporated into this application by reference in their entirety.

[1] Chua, D. K. H. and Song, Y. (2003), “Application of component state model for identifying constructability conflicts in a merged construction schedule”, Advances in Engineering Software, (34), pp. 671-681.

[2] Kang, L. S, Moon, H. S., Park, S. Y., Kim, C. H. and Lee, T. S. (2010), “Improved link system between schedule data and 3D object in 4D CAD system by using WSB code”, KSCE Journal of Civil Engineering, 14(6), pp: 803-814.

[3] Greer, G. L., Hohn, J. T. and Flores, M. L., “System and method for managing construction projects”, U.S. Pat. No. 7,409,392, Aug. 5, 2008. Assignee: GCC, Inc. (San Jose, Calif.).

[4] Kroeger, D. E., “System, method, and article of manufacture for scheduling and document management integration”, U.S. Patent application 2007/0294617, Dec. 20, 2007. Assignee: None.

[5] Eichstaedt, J. C., Eazzetta, B. A., Mullenger, R. L., Wentz, S. A. and Erickson H. T., “System and methods for providing component information in collaborative design, construction and maintenance of fluid processing plants”, U.S. Pat. No. 7,769,614, Aug. 3, 2010. Assignee: Intergraph Technologies Company (Las Vegas, Nev.).

[6] Chernyak, A. H., Gelman B., Savransky, M. and Cherkis, Y., “PLM-supportive CAD-CAM tool for interoperative electrical and mechanical design for hardware electrical systems”, U.S. Pat. No. 7,103,434, Sep. 5, 2006. Assignee: None.

[7] Omansky, A. H. and Kanner, J. L., “A method and system for inspecting and managing information”, WIPO PCT application WO/2008/064240, May 29, 2008. Assignee: Vela Systems, Inc. (Burlington, Mass.).

[8] Blackmon, T. T., “Construction project management system and method”, U.S. Patent application 2005/0171790, Aug. 4, 2005. Assignee: Common Point Inc., acquired by Bentley Systems Inc. (Exton, Pa.).

1. A method for managing a construction project based on component data, the method comprising:
a) associating component data with project information such as construction activities, resources, man hours, and budgets;
b) grouping component data into a database;
c) sorting component data into categories depending on data use;
d) creating work packages based on built-in tradesmen's expertise with constraints needing to be satisfied prior to the work package being released, the constraints comprising resources, budgets, and safety and quality information that relate to the components in the work package; and
e) building a schedule by arranging activities according to a release date of work packages, the release date determined by the satisfaction of the constraints;
wherein the component data and schedule are used to manage the construction project.

2. The method for managing a construction project according to claim 1, further comprising updating the schedule by tracking a state of a components.

3. The method for managing a construction project according to claim 1, further comprising generating reports on a performance evaluation of the construction project.

4. The method for managing a construction project according to claim 1, further comprising the step of retrieving the component data by loading the component data into a tablet or hand-held device.

5. The method for managing a construction project according to claim 4, wherein the component data are loaded into the tablet or hand-held device from the database via a portable computer.

6. The method for managing a construction project according to claim 1, further comprising: retrieving a plurality of components from the database; presenting the plurality of components to a user; receiving a selection of one of the components that has been performed on the project identified by a selected identifier from the user, comprising a value identifying the selected component; and associating a number of hours worked with the selected identifier.

7. The method for managing a construction project according to claim 1, further comprising providing a means to develop cost codes to group components into categories, the means comprising an algorithm to adjust proportions of cost codes according to change of project budget.

8. The method for managing a construction project according to claim 1, further comprising providing a means to estimate a project cost at a level of granularity where the level is selected from a group consisting of component, IWP, CWP, discipline, and project, the means comprising an algorithm to collect man hours from engineering drawings by industry standard rates.

9. The method for managing a construction project according to claim 1, further comprising providing a means to evaluate a work crew's performance down to a component level, the means comprising an algorithm to calculate productivity and generate reports.

10. A computer-readable storage medium having code embodied therein for causing a computer to perform the method of claim 1.

11. A system for managing construction projects, the system comprising: a database; memory; a processor for executing code stored in the memory; a component interface operative to receive component identifiers identifying components of a construction project; a database interface operative to store the component identifiers in the database and further operative to update a construction status of the component identified by the component identifiers; and a component query interface operative to receive component queries comprising the component identifiers; wherein the database interface is operative to search the database and to provide indicators associated with the received component identifiers and their construction status.

12. The system according to claim 11, further comprising a viewer, the viewer comprising: an application program interface operative to provide the component queries to the component query interface, and to receive the indicators from the database; and a display operative to display graphical representations of the components based on the received indicators.

13. The system according to claim 11, further comprising a remote data entry device, the remote data entry device comprising: a user input device operative to receive time values from a user; and an application program interface operative to provide the time values and associated component identifiers to a time interface.

14. The system according to claim 11, further comprising a simulation interface operative to provide a 4D simulation with autonomous agents making decisions on resource allocation, collaborative working among disciplines, evaluation on risks of changes, and predictions of a 16-weeks look ahead, the simulation interface comprising: a method to detect conflicts; a protocol for agents to do negotiation on limited resources; an algorithm to evaluate risks of changes, where the algorithm comprises means to handle the propagation of a change along the work flow.

15. A software program for managing a construction project based on component data, embodied on a computer readable medium, the software program comprising:
current state information for at least one component and its design; decision and accountability information tracking each component and its design up through its current state; a subsystem further comprising: a component database; a search and cross reference engine, operating in coordination with the component database; wherein for each distinct project initiated by a human user the database, engine, and subsystem exchange data with the human user and amongst each other, and in accordance with the decisions and constraints entered by the human user and contained within the software program, produce as an output at least one report of at least one schedule and supporting documentation associated with the schedule.

16. The software program as in claim 15, wherein the database is a relational database which can track and make use of the relationships between and amongst the attributes of its data.

17. The software program as in claim 15, wherein the database tracks for each distinct project a design state, supporting materials state, current interaction, human user, and progress on any associated report, validation, verification, and documentation requirement, from inception through completion of that distinct project.

18. The software program as in claim 15, wherein the search and cross-reference engine further comprises: means using a constraint-based approach for rapid classification and identification of identical, similar and like components; means for reporting for display to a human user both: (a) all components matching the constraints provided to the search and cross-reference engine; and, (b) for each such component, the particulars contained in the databases of such component; and, means for using a comparative description for each attribute and constraint rather than a component's description in a manufacturing perspective, to provide a unified standard of comparison across different manufacturers.

19. The software program as in claim 15, wherein the subsystem further comprises: mean for collecting, collating, and managing the details for each and every component comprising a part of each project; means for providing the current representation of the project to the human user in accordance with the human user's expressed desire, further comprising: means for providing a graphical representation; means for providing a textual representation; means for providing a list representation; means for providing a dependency-tree representation; and, means for providing any combination of the above, depending on the human user's desire for more or less detail concerning the current state of the project involving that component.

20. The software program as in claim 15, wherein the subsystem further comprises: for each project: means for managing the documentation; means for tracking, for accountability purposes, the human sources for changes as they are made; and, means for transferring a component and its associated documentation from one group to another group.

21. The software program as in claim 15, further comprising: means for identifying uncompleted components or schedules; and
means for alerting a human user to such.

22. The software program as in claim 15, further comprising: means for managing design generation information; and, means for managing support for user generation, dissemination, emendation, tracking, and comparison of documents relevant to the user's engineering, document control, manufacturing, purchasing, procurement, inventory, and other management concerns.

23. The software program as in claim 15, further comprising: means for connecting to an internet/intranet; means for searching across the internet/intranet for all potential replacements for any component contained in any of the software program's databases; and, means for reporting the possibility of such replacement to the human user.

24. The software program as in claim 15, further comprising an extension to the search and cross-reference engine that enables any search to use multiple attributes simultaneously.

25. The software program as in claim 15, further comprising a database structure for storing information comprising full facets of component data in a project as well as relation information that track the components in different disciplines.

26. A computerized method for using a commerce application of managing a construction project based on component data, comprising:
a) in a first computer process executed by a computer processor, associating component data with project information such as construction activities, resources, man hours, and budgets;
b) in a second computer process executed by a computer processor, grouping component data into a database;
c) in a third computer process executed by a computer processor, sorting component data into categories depending on data use providing a base to manage the project;
d) in a fourth computer process executed by a computer processor, creating work packages based on built-in tradesmen's expertise with constraints needing to be satisfied prior to the work package being released, the constraints comprising resources, budgets, and safety and quality information that relate to the components in the work package;
e) in a fifth computer process executed by a computer processor, building a schedule by arranging activities according to a release date of work packages, the release date determined by the satisfaction of the constraints;
f) in a sixth computer process executed by a computer processor, updating the schedule by tracking a state of a components; and
g) in a seventh computer process executed by a computer processor, generating reports on a performance evaluation, and
h) in an eighth computer process executed by a computer processor, displaying the information further comprises selectively displaying information selected from a group consisting of a two-dimensional graphical model, a three-dimensional graphical model, text, a bill of materials, and any combination thereof.

27. The method of claim 26 further comprising providing the user with the ability to edit the information.
